(19) United States
(12) Patent Application Publication
(10) Pub. No.: US 2026/0147575 A1
(43) Pub. Date: May 28, 2026

(54) BRANCH PREDICTION USING MULTIPLE TABLES

(71) Applicant: TEXAS INSTRUMENTS INCORPORATED, Dallas, TX (US)

(72) Inventor: Garrett Lies, Dallas, TX (US)

(21) Appl. No.: 18/958,603

(22) Filed: Nov. 25, 2024

(51) Int. Cl. G06F 9/38; G06F 9/355

(52) U.S. Cl. CPC G06F 9/3844; G06F 9/3806

(57) ABSTRACT

Various embodiments of the present disclosure relate to branch prediction within computing systems. In one example embodiment, a technique for performing branch prediction is provided. The technique first includes performing a first comparison between a first portion of a program counter value and a first portion of a cached address. Next, the technique includes performing a second comparison between a second portion of the program counter value and a second portion of the cached address. Finally, the technique includes determining to replace the program counter value with a target address associated with the cached address based at least on the first comparison determining that the first comparison was a match and the second comparison determining that the second comparison was a match.

### TECHNICAL FIELD

Aspects of the disclosure are related to the field of computing hardware and software, and more particularly to, branch prediction.

### BACKGROUND

Branch prediction describes a technique utilized by processing devices for improving the flow of instruction execution. For example, when employed by a computing system, branch prediction allows the computing system to predict the outcome when a branch instruction is executed, thereby improving the efficiency of the computing system. Accordingly, when a branch instruction has been fetched from memory, the computing system may predict the target instruction which the branch instruction will branch to.

Some methods for predicting branches may rely on an instruction buffer, such as a branch target buffer. The branch target buffer may be representative of a local memory that is configured to store the addresses of previously executed instructions. For example, the branch target buffer may be configured to store the addresses of previously executed branch instructions and the addresses of the target instructions which the previously executed branch instructions branched to. Typically, the size of the branch target buffer is dependent on the requirements of the system, and it may be optimal to keep the size of the buffer at a minimum.

Currently, a limited number of methods exist for predicting branches without significant branch prediction computation circuitry. In one example, the central processing unit (CPU) of the device is configured to reference the branch target buffer to determine if an instruction is representative of a branch instruction. For example, the CPU may compare the address of a recently fetched instruction with the address of a previously stored branch instruction. If the CPU determines the addresses are the same, then the CPU concludes that the recently fetched instruction is representative of a branch instruction and in response, forms a prediction on the next instruction to be fetched from memory based on a previous execution of the stored branch instruction. Alternatively, if the CPU determines that the addresses are not the same, then the CPU concludes that the recently fetched instruction is not representative of a branch instruction and continues with normal system operations.

Current methods for performing branch prediction may be unreliable and prone to mispredictions, thusly adding latency to the device. Furthermore, some current methods waste hardware and software resources, without providing a significant enough performance boost to rationalize the area used to implement the instruction buffer and other branch prediction circuitry.

### SUMMARY

Disclosed herein is technology, including systems, methods, and devices for performing branch prediction. Branch prediction is utilized by computing systems for improving the flow of instruction execution. Branch prediction techniques identify branch instructions within program code and predict the outcome when the identified branch instructions are executed. In various implementations, a technique for performing branch prediction is provided.

In one example embodiment, the technique first includes performing a first comparison between a first portion of a program counter value and a first portion of a cached address and performing a second comparison between a second portion of the program counter value and a second portion of the cached address. The program counter value represents the address of the next instruction to be fetched from memory, while the cached address represents the address of an instruction that caused a change in the flow of the program counter (e.g., a branch or jump operation) during a previous execution iteration of the instruction.

For example, the cached address may represent the address of a previously executed branch instruction which has been cached within a branch target buffer. The branch target buffer is representative of a local memory configured to store the addresses of previously executed branch instructions, and the addresses of the target instructions which the previously executed branch instructions branched to. Accordingly, a match of the program counter value and the cached address may indicate that the next instruction is a branch instruction.

Next, the technique includes determining whether the branch instruction is likely to be taken and thus, determining to replace the program counter value with a target address associated with the cached address based on at least, the first comparison determining that the first portion of the program counter value matches the first portion of the cached address and the second comparison determining that the second portion of the program counter value matches the second portion of the cached address. The target address represents the address of a target instruction which the branch instruction of the program counter value is expected to branch to. Thus, replacing the program counter value with the target address while the branch instruction is still being fetched allows for efficient execution of the branch instruction assuming the branch instruction proceeds as predicted.

This Summary is provided to introduce a selection of concepts in a simplified form that are further described below in the Technical Disclosure. It may be understood that this Summary is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment in an implementation.

FIG. 2 illustrates a branch prediction method in an implementation.

FIG. 3 illustrates a system in an implementation.

FIG. 4 illustrates an operational sequence in an implementation.

FIG. 5 illustrates another operational environment in an implementation.

FIG. 6 illustrates a branch prediction process in an implementation.

FIGS. 7A & 7B illustrate an operational scenario in an implementation.

FIG. 8 illustrates another operational environment in an implementation.

FIG. 9 illustrates another branch prediction process in an implementation.

FIGS. 10A & 10B illustrate another operational scenario in an implementation.

FIG. 11 illustrates a state machine in an implementation.

FIG. 12 illustrates another system in an implementation.

### DETAILED DESCRIPTION

Technology is disclosed herein for predicting branches within the program code of a computing system. The branch prediction may be well-suited for processing-constrained computing systems such as laptops, phones, tablets, or another low-end device of the like.

Processing-constrained systems may be relatively simpler in design and relatively lower in cost. To meet these constraints, it may be beneficial to consider if the addition of a certain processing resource provides enough of a performance boost to outweigh the associated cost and area. For example, when determining whether to implement branch prediction within such a system, it may be beneficial to consider if the implementation of a given type of branch prediction circuitry provides a performance boost that is worth the cost and area.

An example technique for performing branch prediction relies on an instruction buffer. The instruction buffer, or branch target buffer, is a type of local memory which includes multiple entries configured to store the data of previously executed branch instructions. For example, the branch target buffer may include eight entries, such that each entry is configured to store an identifier for a previously executed branch instruction, and an identifier for the target instruction which the previously executed branch instruction branched to. An identifier, herein referred to as a tag, is representative of a section of an instruction address. For example, if an instruction address is 32 bits long, then the instruction tag may represent all or a portion (e.g., the last 24 bits) of the instruction address.

In operation, the central processing unit (CPU) of the system may reference the branch target buffer to determine if the address of an instruction represents the address of a previously executed branch instruction. For example, prior to fetching an instruction from memory, the CPU may utilize the least significant bits of the instruction's address to index to an entry within the branch target buffer. Next, the CPU may perform a comparison between the tag of the instruction and the tag of a previously executed branch instruction. If the comparison indicates that the instruction tag matches the tag of the previously executed branch instruction, then the CPU may conclude that the next instruction to be fetched from memory represents the previously executed branch instruction. Alternatively, if the comparison indicates that the instruction tag does not match the tag of the previously executed branch instruction, then the CPU may conclude that the next instruction to be fetched from memory does not represent a branch instruction.

In an implementation, if the CPU determines that the next instruction to be fetched from memory represents a previously executed branch instruction, then the CPU is configured to form a prediction on the next instruction to be fetched from memory based on the previous executions of the cached branch instruction. For example, the CPU may be triggered to fetch the last instruction that the cached branch instruction branched to.

Problematically, some existing techniques for performing branch prediction within some devices are inaccurate, thusly leading to inefficiencies within the computing system. For example, if the CPU mispredicts the next instruction to be fetched from memory in response to the branch instruction, then the CPU will waste execution cycles flushing out the incorrect instruction from the execution pipeline and fetching the appropriate instruction from memory. Furthermore, the instruction buffers of some current techniques are large in size, and due to the unreliability of current methods, may not be worth implementing within some computing systems. In contrast, disclosed herein is a new technique for predicting branches within the software of computing systems which is based on the design constraints of the system and is more reliable than current branch predictors.

In one example embodiment, a technique for performing branch prediction is provided. The technique may be employed by processing circuitry to cause the processing circuitry to predict the outcome when a branch instruction is executed. For example, the technique may cause the processing circuitry to identify the address of the next instruction to be fetched from memory based on the address of a branch instruction.

In an implementation, the technique first causes the processing circuitry to perform a first comparison between a program counter value and a cached address. The program counter value represents the address of the next instruction to be fetched from memory and the cached address represents the address of a previously executed branch instruction. For example, the processing circuitry may be configured to perform a first comparison between a first portion of an instruction address and a first portion of a previously executed branch instruction address and perform a second comparison between a second portion of the instruction address and a second portion of the previously executed branch instruction address. A match of the program counter value and the cached address in the first and second comparisons may indicate that the next instruction is a branch instruction, and determining the match using two separate comparisons may allow the use of smaller tables to store the cached address portions and likewise allow for smaller memories.

In an implementation, to perform the first and second comparisons, the processing circuitry is configured to reference multiple instruction buffers, herein referred to as the branch target buffers. The branch target buffers may be local memories/tables that include multiple entries, configured to store the address data of previously executed branch instructions, and the address data of the target instructions which the previously executed branch instructions branched to. In operation, the processing circuitry may identify an entry within the branch target buffers based on the data of the program counter value, and perform the first and second comparisons between the program counter value and the address data stored by the designated entry of the branch target buffers.

Next, the processing circuitry may provide a first indication of whether the first portion of the program counter value matches the first portion of the cached address and provide a second indication of whether the second portion of the program counter value matches the second portion of the cached address. For example, the processing circuitry may be configured to, for each comparison, output a positive indication when the comparison comprises a match, or alternatively, output a negative indication when the comparison does not comprise a match. In an implementation, if both the first and second indications comprise a match, then the processing circuitry determines that the program counter value represents a branch instruction address. Else, the processing circuitry determines that the program counter value does not represent a branch instruction address.

Finally, the technique determines whether the branch instruction is likely to be taken and thus whether to cause the processing circuitry to update the program counter value based at least on the first and second indications. For example, if the first and second indications both indicate that their respective comparisons were a match, then the technique causes the processing circuitry to determine to replace the program counter value with a target address associated with the cached address. The target address is representative of an address of an instruction which the cached address branched to on a previous execution.

In an implementation, to determine whether to replace the program counter value with the target address, the processing circuitry is configured to reference a table which stores the execution history of the previously executed branch instructions, herein referred to as the pattern history table. The pattern history table is representative of a table, stored in memory, which is configured to store the likeliness of a branch instruction branching to the same location as it did on its most recent execution. In an implementation, the technique causes the processing circuitry to replace the program counter value with the target address when it is likely that the branch instruction will again branch to the target instruction. Alternatively, if either the first or second indications indicate that their respective comparison was not a match, or the processing circuitry determines that it is not likely for the branch instruction to again branch to the target instruction, then the processing circuitry is configured to increment the program counter value.

Advantageously, the proposed technology provides a technique for performing branch prediction in a manner that may minimize the branch prediction processing resources and memory size while still providing more accuracy than some comparable techniques. As a result, the proposed technology may be well-suited for performing branch prediction within processing-constrained computing systems, which reduces the latency and processing cycles of the computing system, thereby improving the efficiency of the system.

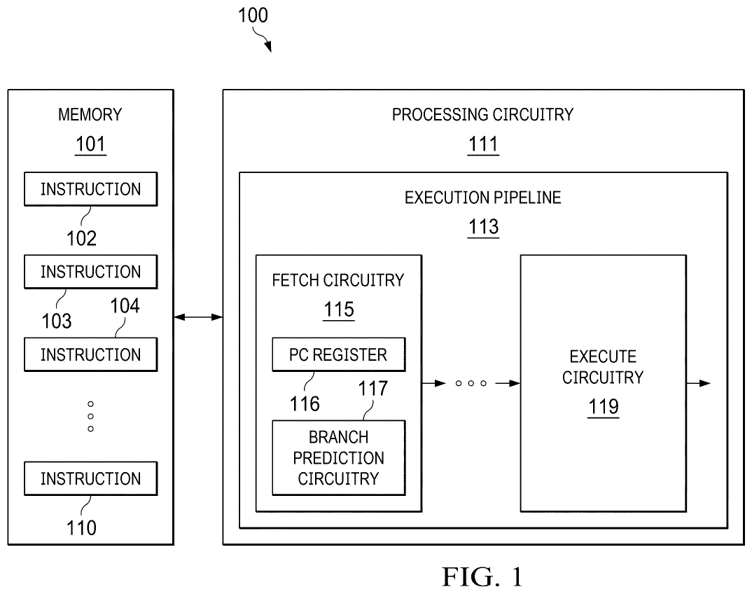

Now turning to the figures, FIG. 1 illustrates an operating environment 100 in an implementation. Operating environment 100 is representative of an example environment configurable to perform branch prediction during the course of normal system operations. For example, operating environment 100 may be representative of a computing system configured to execute program code and predict the outcome of branch instructions during the execution of the program code. Operating environment 100 may be implemented in a variety of contexts, such as automotive, industrial, robotics, power electronics, autonomous systems, or another application of the like. Operating environment 100 includes memory 101 and processing circuitry 111.

Memory 101 is representative of a memory configured to store the program code of operating environment 100. For example, memory 101 may be representative of random-access memory (RAM), static random-access memory (SRAM), flash memory, or another memory of the like configured to store the instructions and data of operating environment 100. In an implementation, memory 101 stores program code to be executed by processing circuitry 111. For example, processing circuitry 111 may be coupled to memory 101 and configured to execute program instructions which were fetched from memory 101. Memory 101 includes, but is not limited to, instructions 102, 103, 104, and 110.

Instructions 102, 103, 104, and 110 are representative of program instructions. For example, instructions 102, 103, 104, and 110 may be representative of linear instructions, branch instructions, or a combination thereof. In an implementation, processing circuitry 111 is configured to fetch instructions 102, 103, 104, and 110 from memory 101, and in response, execute the opcode of the instructions. The opcode of an instruction is representative of a value (e.g., binary, hexadecimal, assembly language) which describes the command of the instruction. For example, if instruction 102 is representative of a conditional branch instruction, then the opcode of instruction 102 may instruct processing circuitry 111 to branch to a first instruction (e.g., instruction 110) when a first condition is met, or branch to a second instruction (e.g., instruction 103) when the first condition is not met.

Processing circuitry 111 is representative of circuitry configured to execute the instructions which were fetched from memory 101. For example, processing circuitry 111 may be representative of a CPU, microcontroller unit (MCU), graphics processing unit (GPU), application specific integrated circuit (ASIC), or another general-purpose processor (GPP) of the like which is configured to execute program code. In an implementation, processing circuitry 111 is further representative of circuitry configured to form predictions on the outcome of branch instructions. For example, processing circuitry 111 may be configured to predict the next instruction to be executed after the execution of a branch instruction, and fetch said instruction subsequent to fetching the branch instruction. Processing circuitry 111 includes, but is not limited to, execution pipeline 113.

Execution pipeline 113 is representative of a series of processing blocks configured to execute the program code of memory 101. For example, execution pipeline 113 may comprise multiple stages, such that each stage is representative of a processing block configured to perform a designated function. Execution pipeline 113 includes, but is not limited to, fetch circuitry 115 and execute circuitry 119.

Fetch circuitry 115 is representative of a processing circuitry configured to fetch program code from memory. For example, fetch circuitry 115 may be configured to fetch instructions 102, 103, 104, and 110 from memory 101. Fetch circuitry 115 includes program counter (PC) register 116 and branch prediction circuitry 117.

PC register 116 is representative of a register configured to store the instruction address of the next instruction to be fetched from memory, herein referred to as the program counter (PC) value. For example, if the PC value of PC register 116 currently represents the address of instruction 102, then fetch circuitry 115 is configured to fetch instruction 102 from memory 101. In an implementation, branch prediction circuitry 117 is configured to examine the PC value of PC register 116 to determine if the PC value represents the address of a previously executed branch instruction.

Branch prediction circuitry 117 is representative of a processing circuitry configured to predict the outcome for executing a branch instruction. More specifically, branch prediction circuitry 117 is representative of a processing circuitry configured to determine if the PC value of PC register 116 represents the address of a previously executed branch instruction, and if so, form a prediction on the target instruction which the PC value is expected to branch to. In an implementation, branch prediction circuitry 117 includes multiple instruction buffers (e.g., branch target buffers), configured to store the data of previously executed branch instructions, and the data of the target instructions which the previously executed branch instructions branched to. For example, the instruction buffers of branch prediction circuitry 117 may include multiple entries, such that each entry is configured to store a tag of a previously executed branch instruction and a tag of the target instruction which the previously executed branch instruction branched to.

A tag is representative of a section (e.g., some or all) of an instruction address. For example, the tag of a 32-bit instruction address may represent the upper 20 bits of the instruction address. In an implementation, branch prediction circuitry 117 includes allocation circuitry configured to store the tags of the previously executed branch instructions, and the tags of the target instructions which the previously executed branch instructions branched to. For example, the allocation circuitry may be configured to determine if an instruction is representative of a branch instruction based on the first execution of the instruction. If the allocation circuitry determines an instruction is representative of a branch instruction, then the allocation circuitry is configured to store the tag of the branch instruction and the tag of the target instruction which the branch instruction branched to within an entry of the instruction buffers. Alternatively, if the allocation circuitry determines the instruction is not representative of a branch instruction, then the allocation circuitry may be configured to flag the instruction as a non-branch instruction.

In an implementation, branch prediction circuitry 117 utilizes the instruction buffers to determine if the current PC value of PC register 116 is representative of a previously executed branch instruction address. If so, then branch prediction circuitry 117 is configured to determine to replace the current PC value with a target address associated with the previously executed branch instruction address. Else, branch prediction circuitry 117 is configured to increment the current PC value. In either case, after fetch circuitry 115 fetches the instruction associated with the current PC value, branch prediction circuitry 117 is configured to update the PC value of PC register 116, and in response, fetch circuitry 115 is configured to fetch the instruction associated with the updated PC value. Output of fetch circuitry 115 is then provided to the next processing circuitry of execution pipeline 113. For example, fetch circuitry 115 may supply the fetched instruction to a decode circuitry which is configured to decode the data of the instruction into a readable format. In an implementation, the decoded instruction is provided to execute circuitry 119.

Execute circuitry 119 is representative of a processing circuitry which is configured to execute program instructions. For example, execute circuitry 119 may receive an instruction from a previous stage of execution pipeline 113, and in response, execute the command of the instruction. In an implementation, output of execute circuitry 119 is provided to a next stage of execution pipeline 113. For example, execution pipeline 113 may include a register write back stage which is configured to store the results of the executed instruction within a register.

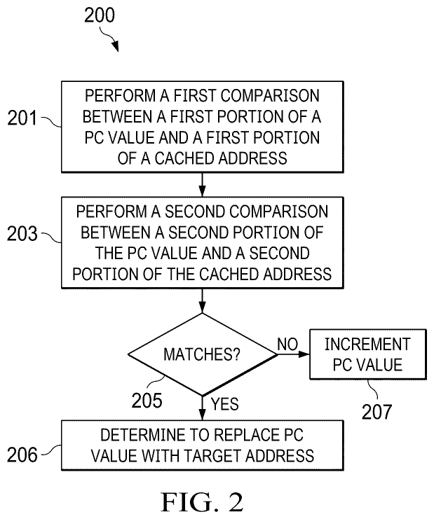

FIG. 2 illustrates branch prediction method 200 in an implementation. Branch prediction method 200 is representative of software for predicting branches within the program code of a computing system. Branch prediction method 200 may be implemented in the context of program instructions that, when executed by a suitable computing system, direct the processing circuitry of the computing system to operate as follows, referring parenthetically to the steps in FIG. 2. For the purposes of explanation, branch prediction method 200 will be explained with the elements of FIG. 1. This is not meant to limit the applications of branch prediction method 200, but rather to provide an example.

To begin, branch prediction circuitry 117 performs a first comparison between a first portion of a PC value and a first portion of a cached branch instruction address (step 201). For example, branch prediction circuitry 117 may be configured to perform a first comparison between a first tag of the PC value and a first tag of the cached branch instruction address in a first branch table. The first tag of the PC value and the first tag of the cached branch instruction address represent the upper bits of the respective addresses. For example, if the PC value and the cached branch instruction address each represent 32-bit addresses, then the first tag of the PC value and the first tag of the cached branch instruction address may represent the upper 17 bits of the respective addresses.

In an implementation, the first branch table that includes the first tag of the cached branch instruction is stored in a first buffer of branch prediction circuitry 117. The first buffer, herein referred to as the shared buffer, is representative of an instruction buffer which comprises multiple entries and is configured to store the first tags of the cached branch instructions, and the first tags of the target instructions which the cached branch instructions previously branched to.

It should be noted that, branch instructions are commonly implemented into program code, and as a result, the addresses of the branch instructions can share similarities. More specifically, the upper bits of multiple branch instruction addresses may be similar, if not the same. Meaning that, a single entry of the shared buffer can store the first tags of multiple branch instructions. For example, if instructions 102, 103, and 104 are all representative of branch instructions, and the addresses of instructions 102, 103, and 104 all share the same upper bits, then a single entry within the shared buffer may be configured to store the first tags of instructions 102, 103, and 104.

In operation, branch prediction circuitry 117 is configured to reference the shared buffer to determine if the first tag of the PC value matches the first tag of the cached branch instruction address. For example, if PC register 116 is currently storing the PC value of instruction 102, then branch prediction circuitry 117 is configured to index to the appropriate entry within the first branch table of the shared buffer and compare the first tag of the PC value with the first tag of the appropriate entry.

Next, branch prediction circuitry 117 performs a second comparison between a second portion of the PC value and a second portion of the cached branch instruction address (step 203). For example, branch prediction circuitry 117 may be configured to perform a second comparison between a second tag of the PC value and a second tag of the cached branch instruction address in a second branch table. In some examples, the second comparison of step 203 is only performed if there is some hit in the shared buffer found in the comparison of step 201. Additionally, or in the alternative, the first comparison of step 201 and the second comparison of step 203 may be performed concurrently. The second tag of the PC value and the second tag of the cached branch instruction address represent the remaining bits of the respective instruction addresses.

The first tag and second tag may represent some or all of the address bits of a known branch instruction. For example, if the PC value and the cached branch instruction address represent 32-bit addresses, and the first tag of the PC value and the first tag of the cached branch instruction address represent the upper 17 bits of the respective addresses, then the second tag of the PC value and the second tag of the cached branch instruction address may represent the subsequent 7 bits of the respective addresses. In the example, the remaining 8 bits of the PC value and the cached branch instruction address are representative of indexes. The index of an address is representative of one or more identifiers which allows branch prediction circuitry 117 to identify the appropriate entries in the first and second branch tables for performing a comparison within an instruction cache.

In an implementation, the second tag of the cached branch instruction is stored in the second branch table of a second buffer of branch prediction circuitry 117. The second buffer, herein referred to as the local buffer, is representative of an instruction buffer which comprises multiple entries and is configured to store the second tags of the cached branch instructions, and the second tags of the target instructions which the cached branch instructions previously branched to. In operation, branch prediction circuitry 117 is configured to reference the local buffer to determine if the second tag of the PC value matches the second tag of the cached branch instruction address. For example, if PC register 116 is currently storing the PC value of instruction 102, then branch prediction circuitry 117 is configured to index to the appropriate entry within the local buffer and compare the second tag of the PC value with the second tag of the appropriate entry.

Once compared, branch prediction circuitry 117 is configured to output a result of the comparisons (step 205). For example, branch prediction circuitry 117 may output a first indication of the first comparison and a second indication of the second comparison. The first and second indications are representative of results which indicate if their respective comparison was a match. In an implementation, if both the first and second indications indicate that their respective comparison was a match, then branch prediction circuitry 117 may conclude that the current PC value of PC register 116 represents a branch instruction address, and in response, determine whether to replace the current PC value with a target address (step 206) based, in part, on a branch history and/or confidence in the branch predication, as described in further detail below.

The target address is representative of an address of an instruction which the cached branch instruction previously branched to. In an implementation, to determine to replace the PC value with the target address, branch prediction circuitry 117 is configured to reference a table which stores the execution history of the previously executed branch instructions. For example, branch prediction circuitry 117 may reference a pattern history table which is configured to store the confidence or likeliness of a branch instruction branching to the same location as it did on its most recent execution.

In an implementation, if branch prediction circuitry 117 determines that is not likely for the current PC value to branch to the target address, then branch prediction circuitry 117 is configured to increment the PC value assuming the branch instruction is not taken, observe the execution of the branch instruction, and update the shared and local buffers with the new target address if the branch is actually taken. Alternatively, if branch prediction circuitry 117 determines that it is very likely that the current PC value will again branch to the target address, then branch prediction circuitry 117 is configured to replace the current PC value with the target address. For example, branch prediction circuitry 117 may index to the appropriate entry within the shared buffer, read the first tag of the target instruction, and write the first tag to PC register 116. Simultaneously, branch prediction circuitry 117 may index to the appropriate entry within the local buffer, read the second tag of the target instruction, and write the second tag to PC register 116. Fetch circuitry 115 may then reference PC register 116 to determine the next instruction to fetch from memory 101.

Alternatively, if either the first or second indications indicate that their respective comparison was not a match, then branch prediction circuitry 117 may conclude that the PC value does not represent a branch instruction address, and in response, increment the PC value (step 207) assuming that the branch instruction is not taken. For example, if the current PC value represents the address of instruction 102, and branch prediction circuitry 117 determines that instruction 102 is not representative of a branch instruction, then branch prediction circuitry 117 is configured to increment the PC value to the next instruction address within memory 101 (i.e., instruction 103).

Advantageously, branch prediction method 200 provides a technique which utilizes smaller instruction buffers than existing branch predictors, thusly reserving the processing resources of the computing system. Furthermore, the reduced size of the instruction buffers allows for the instruction buffers to include a larger number of entries, thereby improving the accuracy for performing branch prediction. As a result, branch prediction method 200 provides a method to predict branches within program code of computing systems.

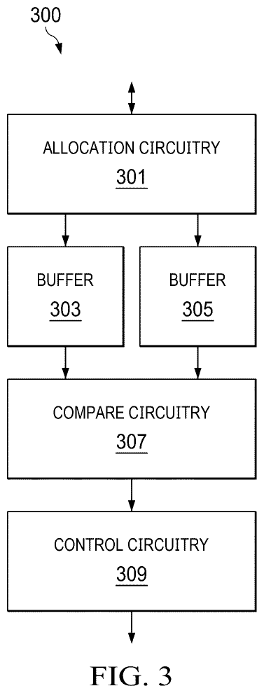

Now turning to the next figure, FIG. 3 illustrates system 300 in an implementation. System 300 is representative of an exemplary system configured to perform branch prediction during the course of normal system operations. For example, system 300 may be representative of branch prediction circuitry 117 of FIG. 1. System 300 includes allocation circuitry 301, shared buffer 303, local buffer 305, compare circuitry 307, and control circuitry 309.

Allocation circuitry 301 is representative of processing circuitry configured to determine if instructions which are currently stored in memory (not shown) are representative of branch instructions. For example, prior to the first execution of an instruction, the allocation circuitry is unsure of whether the instruction is representative of a branch instruction. Once the instruction has been executed, the allocation circuitry may observe the outcome of the instruction to determine if the instruction is representative of a branch instruction. If allocation circuitry 301 determines that the instruction is not representative of a branch instruction, then allocation circuitry 301 may flag the instruction as a non-branch instruction in the memory. Alternatively, if allocation circuitry 301 determines that the instruction is representative of a branch instruction, then allocation circuitry 301 is configured to populate shared buffer 303 and local buffer 305 with the data of the instruction.

Shared buffer 303 is representative of an instruction buffer configured to store a first branch table. Accordingly, the shared buffer 303 may include multiple entries, such that each entry is configured to store the upper bits of a previously executed branch instruction address. More specifically, each entry of shared buffer 303 is configured to store the first tag of a previously executed branch instruction.

A tag represents a portion of an instruction address, such that the first tag represents the upper bits of the instruction address. For example, if the instruction address of a previously executed branch instruction is representative of a 32-bit address, then the first tag of the instruction address may represent the upper 17 bits of the address. Advantageously, branch instructions are commonplace in program code, and as a result, shared buffer 303 may utilize a singular entry to store the first tags of multiple branch instructions. For example, if five separate branch instructions share the same first tag, then a singular entry within shared buffer 303 may store the first tag for the five separate branch instructions.

Local buffer 305 is representative of another instruction buffer configured to store a second branch table. Accordingly, the local buffer 305 may include multiple entries, such that each entry is configured to store the lower bits of a previously executed branch instruction address, and the lower bits of a target instruction address which the previously executed branch instruction branched to. More specifically, each entry of local buffer 305 is configured to store the second tag of a previously executed branch instruction, and the second tag of the target instruction which the previously executed branch instruction branched to.

The second tag of an instruction represents the remaining bits of an instruction address, not including the least significant bits of the instruction address. For example, if the instruction address of a previously executed branch instruction is representative of a 32-bit address, and the first tag represents the upper 17 bits of the address, then the second tag may represent the subsequent 7 bits of the address, such that the remaining 8 bits of the address represent the index of the address. The index of an address is representative of an identifier which determines the appropriate entry, within shared buffer 303 or local buffer 305, to respectively store the first or second tags.

In an implementation, allocation circuitry 301 is configured to populate the branch tables of shared buffer 303 and local buffer 305. For example, after the first execution of an instruction from memory, allocation circuitry 301 may determine that the instruction is representative of a branch instruction. If allocation circuitry 301 determines that the instruction is representative of a branch instruction, then allocation circuitry 301 is configured to store the first tag of the instruction within an entry of the first branch table of shared buffer 303 based on the index of the instruction. In addition, allocation circuitry 301 configured to also store the second tag of the instruction and the second tag of the target instruction within an entry of the second branch table of local buffer 305, also based on the index of the instruction. It should be noted that, when storing the first tag of the instruction, the allocation circuitry may determine that the first tag has already been stored after the execution of a different branch instruction. In an implementation, after populating shared buffer 303 and local buffer 305, compare circuitry 307 may utilize the data stored by the tables of the buffers to determine if a recently fetched instruction is representative of a previously executed branch instruction.

Compare circuitry 307 is representative of processing circuitry configured to perform comparisons between the address of the next instruction to be fetched from memory and the address of a previously executed branch instruction. For example, compare circuitry 307 may be configured to compare the tags of the next instruction to be fetched from memory with the tags of a cached branch instruction to determine if the next instruction to be fetched from memory represents the cached branch instruction.

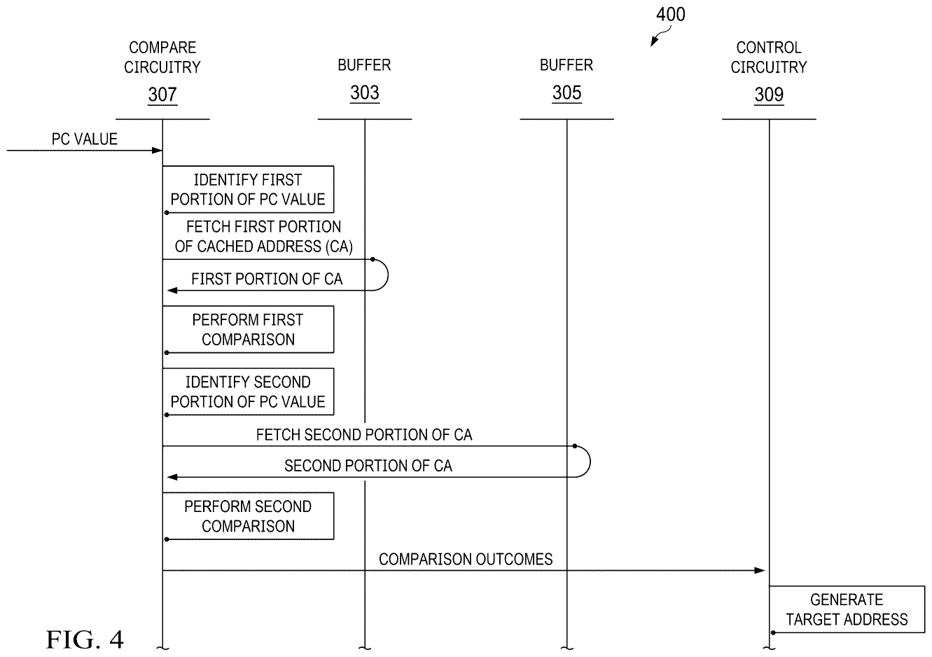

In an implementation, compare circuitry 307 includes a register configured to store the address data of the next instruction to be fetched from memory. For example, compare circuitry 307 may include a PC register (e.g., PC register 116) configured to store a PC value. The PC value represents the address of the next instruction to be fetched from memory. In operation, compare circuitry 307 performs comparisons between the tags of the PC value and the tags of a previously executed branch instruction to determine if the PC value represents the address of the previously executed branch instruction, later discussed in detail with reference to FIG. 4. Output of compare circuitry 307 is provided to control circuitry 309.

Control circuitry 309 is representative of circuitry configured to determine the next instruction to be fetched from memory based on the output of compare circuitry 307. For example, if compare circuitry 307 determines that the PC value represents the address of a previously executed branch instruction, then control circuitry 309 is configured to determine whether to replace the PC value with a target address. Alternatively, if compare circuitry 307 determines that the PC value is not representative of a previously executed branch instruction, then control circuitry 309 is configured to increment the PC value.

FIG. 4 illustrates an operational sequence in an implementation. Operational sequence 400 is representative of a sequence for performing branch prediction with respect to the elements of FIG. 3. As such, operational sequence 400 includes compare circuitry 307, shared buffer 303, local buffer 305, and control circuitry 309.

To begin, the PC register of compare circuitry 307 is supplied with a PC value. Once stored in the PC register, compare circuitry 307 is configured to identify the first tag of the PC value. The PC value may be divided into three portions or four portions, a first tag for the first comparison, a second tag for the second comparison, and one or more indexes for accessing the shared and local buffers. For example, compare circuitry 307 may identify the upper 17 bits of the PC value as the first tag. Once identified, compare circuitry 307 is configured to fetch a first tag of a previously cached branch instruction from the first branch table in shared buffer 303 using an index (e.g., the lowest 8 bits of the PC value) that specifies an entry of the shared buffer 303.

In an implementation, to fetch the first tag from shared buffer 303, compare circuitry 307 is configured to identify the appropriate entry within the first branch table of shared buffer 303 to read-out data from based on the index of the PC value. For example, compare circuitry 307 may utilize the index of the PC value to identify the appropriate entry within the first branch table to read-out data from. Once identified, compare circuitry 307 is configured to fetch the first tag of the previously executed branch instruction, and compare the first tag of the previously executed branch instruction with the first tag of the PC value.

The compare circuitry 307 is also configured to identify the second tag of the PC value. For example, compare circuitry 307 may identify the subsequent 7 bits of the PC value. Once identified, compare circuitry 307 is configured to fetch the second tag of the previously cached branch instruction from the second branch table in local buffer 305 using an index of the PC value, which may be the same subset of the PC value as the index used to access the shared buffer 303 or a different subset of the PC value.

In an implementation, to fetch the second tag from local buffer 305, compare circuitry 307 is first configured to identify the appropriate entry within the second branch table of local buffer 305 to read-out data from. For example, compare circuitry 307 may utilize the same index of the PC value or a different index thereof to identify the appropriate entry within the second branch table to read-out data from. Once identified, compare circuitry 307 is configured to fetch the second tag of the previously executed branch instruction, and compare the second tag of the previously executed branch instruction with the second tag of the PC value.

Once compared, compare circuitry 307 is configured to provide the results of the comparisons to control circuitry 309. For example, compare circuitry 307 may provide a first indication of the first comparison and a second indication of the second comparison to control circuitry 309. In an implementation, if both the first and second indications indicate that their respective comparison was a match, then control circuitry 309 concludes that the PC value is representative of an address of a previously executed branch instruction, and in response, determines to replace the PC value with a target address.

The target address is representative of an address of a target instruction which the instruction represented by the current PC value previously branched to. Some or all of the address of the target instruction may be stored in the respective entry in the second branch table in local buffer 305. In an implementation, to determine to replace the current PC value with the target address, control circuitry 309 is configured to reference a table that stores the execution history of the previously executed branch instructions. For example, control circuitry 309 may reference a pattern history table, described in more detail below, which is configured to store the likeliness of a branch instruction branching to the same location as it did on its most recent execution.

If control circuitry 309 determines that it is likely that the current PC value will again branch to the target address, then branch prediction circuitry 117 is configured to replace the current PC value with the generated target address. In an implementation, to generate the target address, control circuitry 309 is configured to combine the first tag of the previously executed branch instruction from the first branch table with the second tag of the target instruction from the second branch table. For example, control circuitry 309 may index to the appropriate entries within shared buffer 303 and local buffer 305, read-out the first and second tags from the entries, and combine the first tag of the previously executed branch instruction with the second tag of the target instruction. Once combined, control circuitry 309 is configured to replace the current PC value with the combined address.

Alternatively, if either the first or second indications indicate that their respective comparison was not a match, or control circuitry 309 determines that is not likely that the current PC value will again branch to the target address, then control circuitry 309 is configured to increment the current PC value. For example, if the current PC value represents an instruction stored in memory, then the incremented PC value may represent the subsequent instruction within memory.

In either case, after updating the PC value, control circuitry 309 is configured to fetch the instruction associated with the updated PC value from memory. For example, if control circuitry 309 determined that the previous PC value represented the address of a branch instruction, and control circuitry 309 observes that its prediction was correct, then control circuitry 309 is configured to fetch the target instruction from memory. Alternatively, if control circuitry 309 determined that the previous PC value did not represent the address of a branch instruction, then control circuitry 309 is configured to fetch the instruction with an address represented by the incremented PC value.

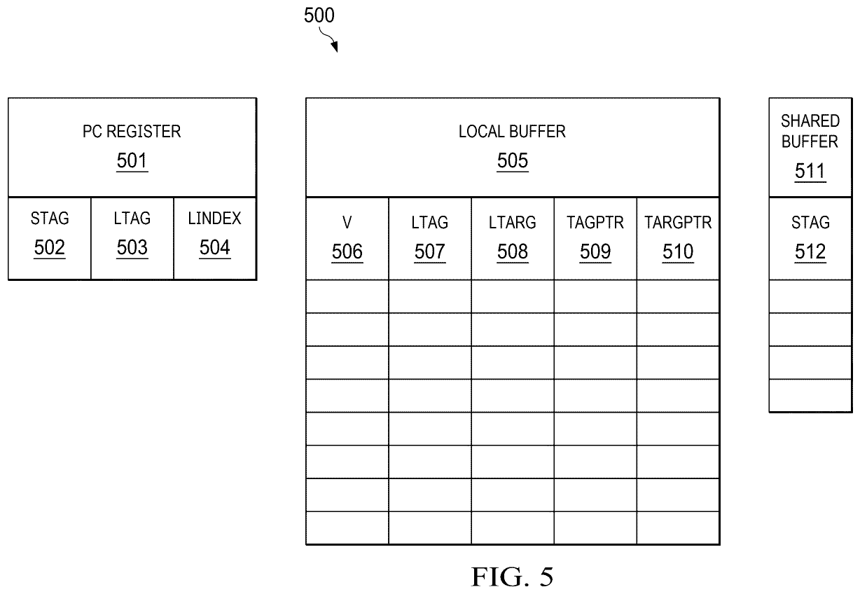

Now turning to the next figure, FIG. 5 illustrates operating environment 500 in an implementation. Operating environment 500 is representative of an example environment configurable to determine if an instruction is representative of a previously executed branch instruction. For example, operating environment 500 may be representative of fetch circuitry 115 of FIG. 1, or system 300 of FIG. 3. Operating environment 500 includes, program counter (PC) register 501, local buffer 505, and shared buffer 511.

PC register 501 is representative of a register configured to store the address data of the next instruction to be fetched from memory, herein referred to as the PC value. For example, PC register 501 may be representative of PC register 116 of FIG. 1. In an implementation, PC register 501 is configured to store a PC value divided into an upper tag 502, lower tag 503, and index 504.

In an example, upper tag 502 represents the upper bits of the PC value. For example, if the PC value is representative of a 32-bit address, then upper tag 502 may represent the upper 20 bits of the address. Lower tag 503 represents the subsequent bits of the PC value. For example, lower tag 503 may represent the subsequent 7 bits of the PC value. Index 504 represents the least significant bits of the PC value. For example, index 504 may represent the last 5 bits of the PC value. In an implementation, processing circuitry coupled to PC register 501 (e.g., branch prediction circuitry 117 or compare circuitry 307) is configured to compare the data of PC register 501 with the data of local buffer 505 and the data of shared buffer 511 to determine if the PC value of PC register 501 represents the address of a previously executed branch instruction.

Local buffer 505 is representative of an instruction buffer configured to store a first branch table. The local buffer 505 may include multiple entries, such that each entry is configured to store the data of previously executed branch instructions and each entry has a corresponding index value. For example, local buffer 505 may be representative of local buffer 305 of FIG. 3. In an implementation, local buffer 505 includes eight entries (i.e., rows). Meaning, local buffer 505 is configured to store the data of eight different branch instructions which have been previously executed. This specification is not meant to limit the applications of local buffer 505, but rather to provide an example.

In an implementation, each entry of local buffer 505 is configured to store validity data, a lower instruction tag, a lower target tag, an instruction tag pointer, and a target tag pointer of a previously executed branch instruction. As such, local buffer 505 includes validity column 506, lower instruction tag column 507, lower target tag column 508, instruction tag pointer column 509, and target tag pointer column 510.

Validity column 506 is representative of a column which is configured to store a valid bit for each entry of local buffer 505. The valid bit of an entry is representative of a bit which provides an indication on whether the data stored in the remaining columns of that entry is accurate. Meaning, the valid bit of an entry indicates if the data of lower instruction tag column 507, lower target tag column 508, instruction tag pointer column 509, and target tag pointer column 510 has been corrupted. In an implementation, validity column 506 is configured to store a 1 if the associated entry comprises valid data, and alternatively store a 0 if the associated entry comprises invalid data.

Lower instruction tag column 507 is representative of a column which is configured to store the lower tags of the previously executed branch instructions. The lower tag of a previously executed branch instruction represents a portion of the branch instruction address. For example, if the branch instruction address is representative of a 32-bit address, and the upper tag of the instruction address represents the upper 20 bits of the address, then each entry of lower instruction tag column 507 may be configured to store the subsequent 7 bits of the instruction address.

Lower target tag column 508 is representative of a column which is configured to store at least a portion of an address (e.g., the lower tags) of the target instructions which the previously executed branch instructions respectively branched to. For example, if the target address is representative of a 32-bit address, and the upper tag of the target address represents the 20 bits of the target address, then each entry of lower target tag column 508 may be configured to store the subsequent 10 bits of the target address.

Instruction tag pointer column 509 is representative of a column which is configured to store a pointer value. The pointer value of instruction tag pointer column 509 is representative of a value which identifies the entry within shared buffer 511 which is storing the upper tag for the associated branch instruction address. For example, processing circuitry may utilize the pointer value of instruction tag pointer column 509 to determine the appropriate entry within shared buffer 511 for performing branch prediction.

Similarly, target tag pointer column 510 is representative of another column which is configured to store a pointer value. The pointer value of target tag pointer column 510 is representative of a value which identifies the entry within shared buffer 511 which is storing the upper tag for the associated target address. For example, processing circuitry may utilize the pointer value of target tag pointer column 510 to identify the appropriate entry within shared buffer 511 for generating the target address.

Shared buffer 511 is representative of another instruction buffer configured to store a second branch table. The shared buffer 511 may include multiple entries, such that each entry is configured to store the data of previously executed branch instructions, and each entry has a corresponding pointer value. For example, shared buffer 511 may be representative of shared buffer 303 of FIG. 3. In an implementation, shared buffer 511 includes four entries (i.e., rows). Meaning, shared buffer 511 is configured to store the data of at least four different branch instructions which have been previously executed. This specification is not meant to limit the applications of shared buffer 511, but rather to provide an example.

In an implementation, each entry of shared buffer 511 is configured to store an upper instruction tag. As such, shared buffer 511 includes upper instruction tag column 512. Upper instruction tag column 512 is representative of a column which is configured to store the upper tags of the previously executed branch instructions, and the upper tags of the target instructions which the previously executed branch instructions branched to. The upper tag represents a portion of a branch instruction address. For example, if a branch instruction address is representative of a 32-bit address, then the upper tag of the instruction address may represent the upper 20 bits of the address.

In an implementation, the entries of local buffer 505 and shared buffer 511 are populated by allocation circuitry configured to determine if an instruction is representative of a branch instruction based on the first execution of the instruction. For example, prior to the first execution of an instruction, the allocation circuitry is unsure of whether the instruction is representative of a branch instruction. Once the instruction has been executed, the allocation circuitry may observe the outcome of the instruction to determine if the instruction is representative of a branch instruction.

If the allocation circuitry determines the instruction is representative of a branch instruction, then the allocation circuitry is configured to store the lower instruction tag, the lower target tag, the instruction tag pointer, and the target tag pointer of the instruction within the appropriate entry of local buffer 505 and, store the upper instruction tag of the instruction within the appropriate entry of shared buffer 511. It should be noted that, when storing the instruction data of a branch instruction, the allocation circuitry may determine that the instruction data has already been stored within local buffer 505 and shared buffer 511. In such cases, the allocation circuitry is configured to invalidate the current data of the entry by setting the validity bit from 1 to 0 and replace the invalidated data with the instruction data of the newly identified instruction

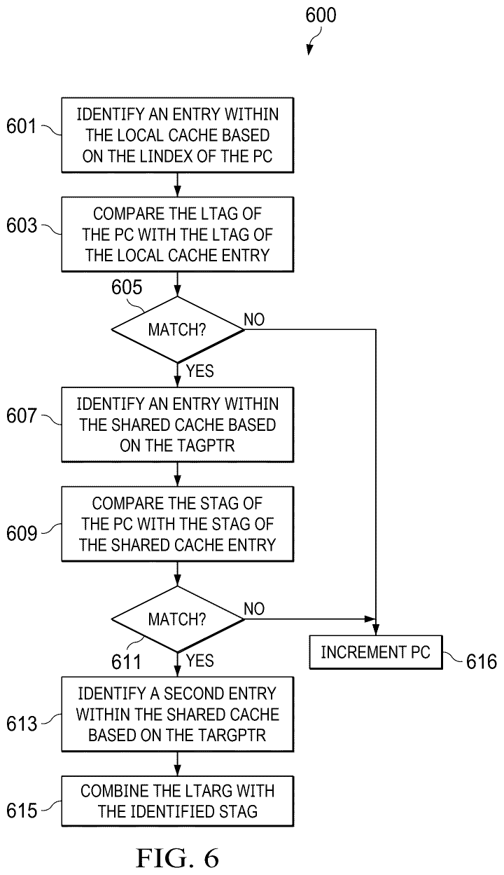

FIG. 6 illustrates branch prediction process 600 in an implementation. Branch prediction process 600 is representative of software for predicting branches within the program code of a computing system. For example, branch prediction process 600 may be representative of branch prediction method 200 of FIG. 2. Branch prediction process 600 may be implemented in the context of program instructions that, when executed by a suitable computing system, direct the processing circuitry of the computing system to operate as follows, referring parenthetically to the steps in FIG. 6. For the purposes of explanation, branch prediction process 600 will be explained with the elements of FIG. 5. This is not meant to limit the applications of branch prediction process 600, but rather to provide an example.

To begin, processing circuitry associated with operating environment 500 utilizes index 504 of PC register 501 to identify the entry within the first branch table of the local buffer 505 that stores the necessary data for performing a first comparison (step 601). For example, index 504 may be representative of a 3-bit binary value which corresponds to an entry of local buffer 505 and a corresponding entry of the first branch table. Thus, if index 504 is equal to 110, then the processing circuitry is configured to utilize data from the seventh entry (i.e., seventh row) of local buffer 505 to determine if the PC value of PC register 501 is representative of a branch instruction address.

Next, the processing circuitry performs the first comparison between lower tag 503 and the lower tag of a previously executed branch instruction (step 603). For example, after indexing to the appropriate entry within local buffer 505, the processing circuitry may perform a comparison between lower tag 503, and the lower instruction tag stored by lower instruction tag column 507. Once compared, the processing circuitry is configured to output a result of the comparison (step 605).

In an implementation, if the processing circuitry determines that lower tag 503 does not match the lower tag of the previously executed branch instruction, then the processing circuitry may conclude that the PC value of PC register 501 is not representative of a previously cached branch instruction address, and in response, increment the PC value (step 616). For example, the processing circuitry may be configured to increment the PC value to cause the PC value to represent the address of the instruction stored in memory that immediately follows the current instruction. Alternatively, if the processing circuitry determines that lower tag 503 matches the lower tag of the previously cached branch instruction address, then the processing circuitry is configured to identify the entry within the second branch table of the shared buffer 511 that stores the necessary data for performing a second comparison (step 607).

In an implementation, to identify the appropriate entry within shared buffer 511 for performing the second comparison, the processing circuitry is configured to utilize the pointer value stored by instruction tag pointer column 509 of local buffer 505. For example, the pointer value of instruction tag pointer column 509 may be representative of a 2-bit binary value which corresponds to an entry of shared buffer 511 and a corresponding entry of the second branch table. Thus, if the pointer value is equal to 00, then the processing circuitry is configured to utilize data from the first entry (i.e., first row) of shared buffer 511 to perform the second comparison.

Next, the processing circuitry performs the second comparison between upper tag 502 and the upper tag of a previously executed branch instruction (step 603). For example, after identifying the appropriate entry within shared buffer 511, the processing circuitry may perform a comparison between upper tag 502, and the upper instruction tag stored by the appropriate entry of upper instruction tag column 512. Once compared, the processing circuitry is configured to output a result of the comparison (step 611).

In an implementation, if the processing circuitry determines that upper tag 502 does not match the upper tag of the previously executed branch instruction, then the processing circuitry may conclude that the PC value of PC register 501 is not representative of a previously cached branch instruction address, and in response, increment the PC value (step 616). Alternatively, if the processing circuitry determines that upper tag 502 matches the upper tag of the previously cached branch instruction address, then the processing circuitry may conclude that the PC value of PC register 501 is representative of a branch instruction address, and in response, determine to replace the PC value with a target address.

In an implementation, to determine to replace the current PC value with the target address, the processing circuitry is configured to reference a table that stores the execution history of the previously executed branch instructions. For example, the processing circuitry may reference a pattern history table, described in more detail below, which is configured to store the likeliness of a branch instruction branching to the same location as it did on its most recent execution.

If the processing circuitry determines that it is not likely that the current PC value will again branch to the target address, then the processing circuitry is configured to increment the current PC value (step 616). Alternatively, if the processing circuitry determines that it is likely that the current PC value will again branch to the target address, then the processing circuitry is configured to replace the current PC value with the generated target address. In an implementation, to generate the target address, the processing circuitry is first configured to identify a second entry within shared buffer 511, such that the second entry stores the upper tag of the target address (step 613). For example, the processing circuitry may utilize the pointer value (e.g., 11) stored by target tag pointer column 510 of local buffer 505 to identify the entry (e.g., fourth row) within shared buffer 511 that stores the upper bits of the target instruction.

Once identified, the processing circuitry is configured to generate the target address by combining the identified upper tag with the lower target tag stored by lower target tag column 508 of local buffer 505 (step 615). Finally, the processing circuitry is configured to replace the previous PC value of PC register 501 with the newly generated target address. It should be noted that branch prediction process 600 is a repetitive process. For example, branch prediction process 600 may be executed for each PC value that is stored by PC register 501.

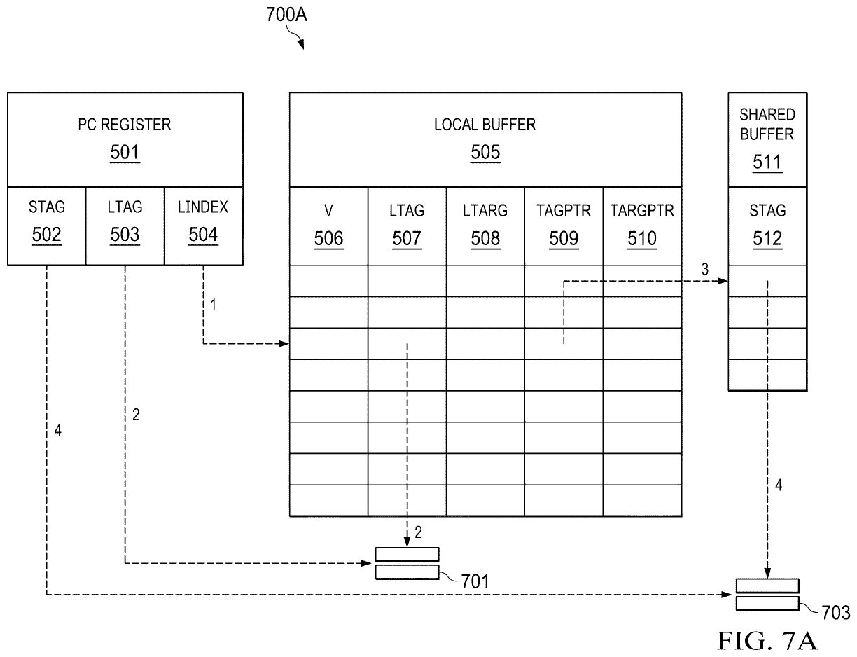

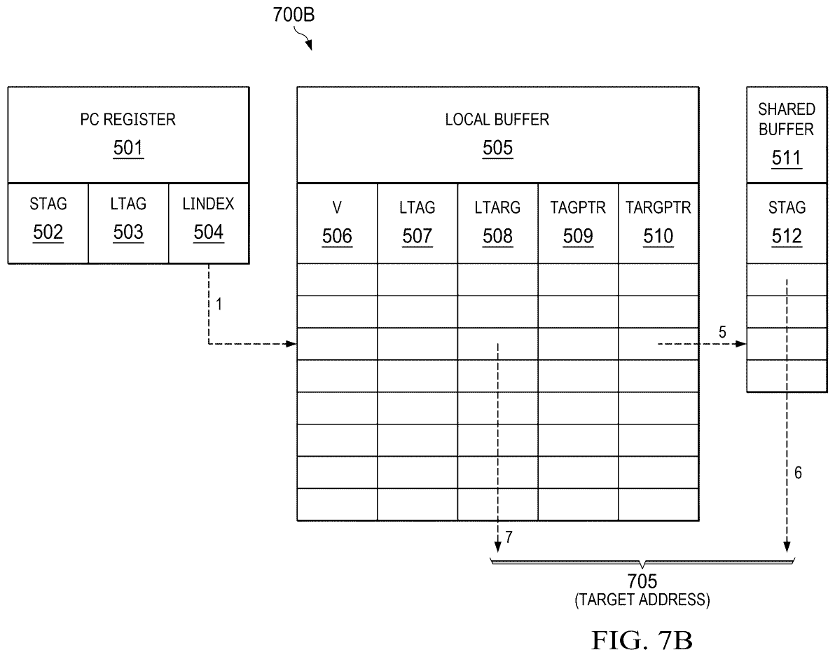

FIGS. 7A and 7B illustrate an operational scenario for performing branch prediction with respect to the elements of FIG. 5. More specifically, FIG. 7A illustrates a first stage of the operational scenario while FIG. 7B illustrates a second stage of the operational scenario. As such, FIGS. 7A and 7B include PC register 501, local buffer 505, and shared buffer 511.

Turning to the first stage of the operational scenario, FIG. 7A depicts stage 700A in an implementation. Stage 700A is representative of a stage for determining if the PC value of PC register 501 is representative of a branch instruction address. To begin, the processing circuitry is configured determine the appropriate entry within the first branch table of the local buffer 505 based on index 504. For example, index 504 may cause the processing circuitry to index to the third entry of local buffer 505.

Next, the processing circuitry is configured to determine if the data of the third entry has been corrupted. For example, the processing circuitry may reference the valid bit of validity column 506 to confirm the data stored by the remaining columns of the third entry is uncorrupted. Once confirmed, the processing circuitry is configured to execute operation 701. Operation 701 is representative of a comparison operation between lower tag 503 and the lower tag of the previously cached branch instruction. For example, the processing circuitry may be configured to determine if the bits of lower tag 503 match the bits stored by the third entry of lower instruction tag column 507.

After confirming lower tag 503 matches the lower tag of the previously executed branch instruction, the processing circuitry is then configured to determine the appropriate entry within the second branch table of shared buffer 511 based on the pointer value stored by the third entry of instruction tag pointer column 509. For example, the pointer value of instruction tag pointer column 509 may cause the processing circuitry to index to the first entry of shared buffer 511.

Next, the processing circuitry is configured to execute operation 703. Operation 703 is representative of a comparison operation between upper tag 502 and the upper tag of the previously executed branch instruction. For example, the processing circuitry may be configured to determine if the bits of upper tag 502 match the bits stored by the first entry of upper instruction tag column 512. In an implementation, if the processing circuitry determines the results of operations 701 and 703 comprise a match, then the processing circuitry may conclude that the current PC value of PC register 501 is representative of a branch instruction address.

Now turning to the next figure, FIG. 7B illustrates stage 700B in an implementation. Stage 700B is representative of a stage for generating a target address to replace the PC value of PC register 501. To begin, the processing circuitry is configured to index to the appropriate entry within shared buffer 511 based on the pointer value stored by the third entry of target tag pointer column 510. For example, the pointer value of target tag pointer column 510 may cause the processing circuitry to index to the third entry of shared buffer 511.

Next, the processing circuitry is configured to generate target address 705. Target address 705 represents the address of the next instruction to be fetched from memory. More specifically, target address 705 represents the processing circuitry's prediction on the outcome from executing the current instruction represented by the PC value of PC register 501. In an implementation, to generate the target address, the processing circuitry is configured to combine the identified upper tag with the lower tag stored by the third entry of lower target tag column 508. Once combined, the processing circuitry may replace the current PC value with the generated target address.

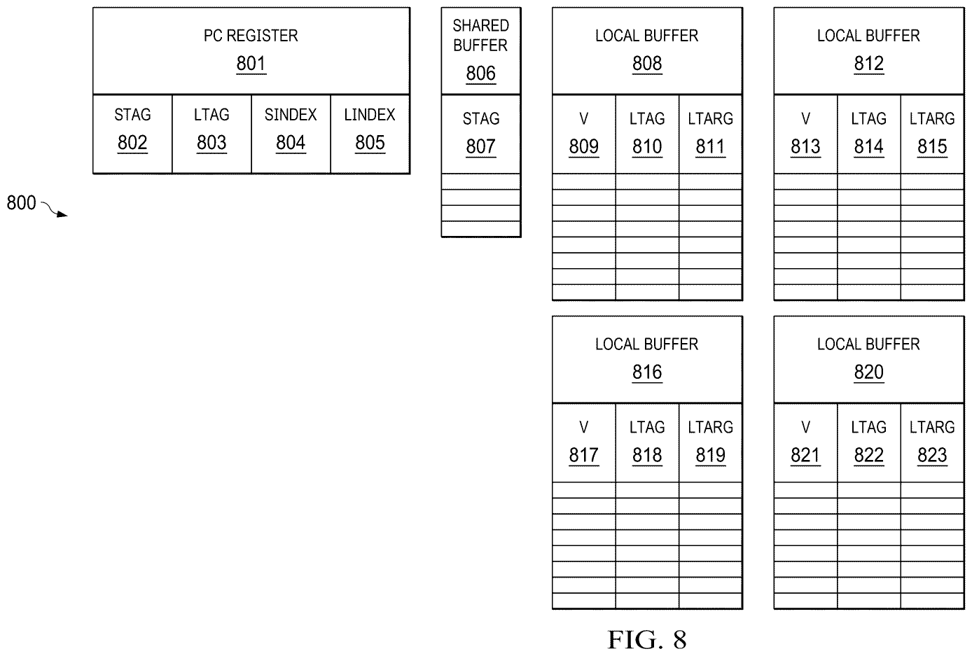

Now turning to the next figure, FIG. 8 illustrates operating environment 800 in an implementation. Operating environment 800 is representative of another example environment configurable to determine if an instruction recently fetched from memory is representative of a previously executed branch instruction. For example, operating environment 800 may be representative of fetch circuitry 115 of FIG. 1, or system 300 of FIG. 3. Operating environment 800 includes, program counter (PC) register 801, shared buffer 806, local buffer 808, local buffer 812, local buffer 816, and local buffer 820.

PC register 801 is representative of a register configured to store the address data of the next instruction to be fetched from memory, herein referred to as the PC value. For example, PC register 801 may be representative of PC register 116 of FIG. 1, or PC register 501 of FIG. 5. In an implementation, PC register 801 is configured to store a PC value that includes upper tag 802, lower tag 803, index 804, and index 805 of the PC value.

Upper tag 802 represents the upper bits of the PC value. For example, if the PC value is representative of a 32-bit address, then upper tag 802 may represent the upper 18 bits of the address. Lower tag 803 represents the subsequent bits of the PC value. For example, lower tag 803 may represent the subsequent 7 bits of the PC value. Index 804 and index 805 represent bits five through six and two through four of the PC value respectively. For example, if upper tag 802 and lower tag 803 represent the first 25 bits of a 32-bit PC value, then index 804 may represent the subsequent 2 bits of the PC value and index 805 may represent the next 3 bits of the PC value. It should be noted that in some implementations, the remaining 2 bits of the PC value may not be used in systems where the memory is byte addressable, and all the instructions are 32 bits in length. In an implementation, index 804 and index 805 are representative of indicators which identify the appropriate locations within shared buffer 806, and local buffers 808, 812, 816, and 820, for determining if the current PC value represents the address of a previously executed branch instruction.

Shared buffer 806 is representative of an instruction buffer configured to store a first branch table. Shared buffer 806 may include multiple entries, such that each entry is configured to store the data of previously executed branch instructions. For example, shared buffer 806 may be representative of shared buffer 303 of FIG. 3 or shared buffer 511 of FIG. 5. In an implementation, shared buffer 806 includes four entries (i.e., rows). Meaning, shared buffer 806 is configured to store the data of at least four different branch instructions which have been previously executed. This specification is not meant to limit the applications of shared buffer 806, but rather to provide an example.

In an implementation, each entry of shared buffer 806 is configured to store an upper instruction tag. As such, shared buffer 806 includes upper instruction tag column 807. Upper instruction tag column 807 is representative of a column which is configured to store the upper tags of the previously executed branch instructions, and the upper tags of the target instructions which the previously executed branch instructions branched to. The upper tag represents a portion of an instruction address. For example, if an instruction address is representative of a 32-bit address, then the upper tag of the address may represent the upper 18 bits of the address.

Local buffers 808, 812, 816, and 820 are also representative of instruction buffers each configured to store a corresponding second branch table. Each of the local buffers 808, 812, 816, and 820 may include multiple entries, such that each entry of local buffers 808, 812, 816, and 820 is configured to store the data of a previously executed branch instruction. For example, local buffers 808, 812, 816, and 820 may be representative of local buffer 305 of FIG. 3 or local buffer 505 of FIG. 5. In an implementation, each buffer of local buffers 808, 812, 816, and 820 includes eight entries (i.e., rows). Meaning, each buffer of local buffers 808, 812, 816, and 820 is configured to store the data of eight different branch instructions which have been previously executed. This specification is not meant to limit the applications of local buffers 808, 812, 816, and 820, but rather to provide an example.

In an implementation, each entry of local buffers 808, 812, 816, and 820 is configured to store validity data, a lower instruction tag, and a lower target tag of a previously executed branch instruction. As such, local buffer 808 includes validity column 809, lower instruction tag column 810, and lower target tag column 811, local buffer 812 includes validity column 813, lower instruction tag column 814, and lower target tag column 815, local buffer 816 includes validity column 817, lower instruction tag column 818, and lower target tag column 819, and local buffer 820 includes validity column 821, lower instruction tag column 822, and lower target tag column 823.

Validity columns 809, 813, 817, and 821 are representative of columns which are configured to store a valid bit for each entry of their respective local buffer. For example, validity column 809 stores the valid bits for each entry of lower instruction tag column 810 and lower target tag column 811, while validity column 813 stores the valid bits for each entry of lower instruction tag column 814 and lower target tag column 815. The valid bit of an entry is representative of a bit which provides an indication on whether the data of the entry has been corrupted. In an implementation, validity columns 809, 813, 817, and 821 are configured to store a 1 if the associated entry comprises valid data, and alternatively store a 0 if the associated entry comprises invalid data.

Lower instruction tag columns 810, 814, 818, and 822 are representative of columns configured to store the lower tags of the previously executed branch instructions. The lower tag of a previously executed branch instruction represents a portion of the branch instruction address. For example, if the branch instruction address is representative of a 32-bit address, and the upper tag of the instruction address represents the upper 18 bits of the address, then each entry of lower instruction tag columns 810, 814, 818, and 822 may be configured to store the subsequent 7 bits of the instruction address.

Lower target tag columns 811, 815, 819, and 823 are representative of columns configured to store the lower tags of the target instructions which the previously executed branch instructions respectively branched to. For example, if the target address is representative of a 32-bit address, and the upper tag of the target address represents the upper 18 bits of the target address, then each entry of lower target tag columns 811, 815, 819, and 823 may be configured to store the subsequent 12 bits of the target address.

In an implementation, the entries of shared buffer 806, local buffer 808, local buffer 812, local buffer 816, and local buffer 820 are populated by allocation circuitry configured to determine if an instruction is representative of a branch instruction based on the first execution of the instruction. For example, prior to the first execution of an instruction, the allocation circuitry is unsure of whether the instruction is representative of a branch instruction. Once the instruction has been executed, the allocation circuitry may observe the outcome of the instruction to determine if the instruction is representative of a branch instruction.

If the allocation circuitry determines the instruction is representative of a branch instruction, then the allocation circuitry is configured to store the upper instruction tag of the instruction within the appropriate entry of shared buffer 806 and, store the lower instruction tag and the lower target tag of the instruction within the appropriate entry of the appropriate local buffer. It should be noted that, when storing the instruction data of a branch instruction, the allocation circuitry may determine that the instruction data has already been stored within shared buffer 806, local buffer 808, local buffer 812, local buffer 816, and local buffer 820. In such cases, the allocation circuitry is configured to invalidate the current data of the entry by setting the validity bit from 1 to 0 and replace the invalidated data with the instruction data of the newly identified instruction.

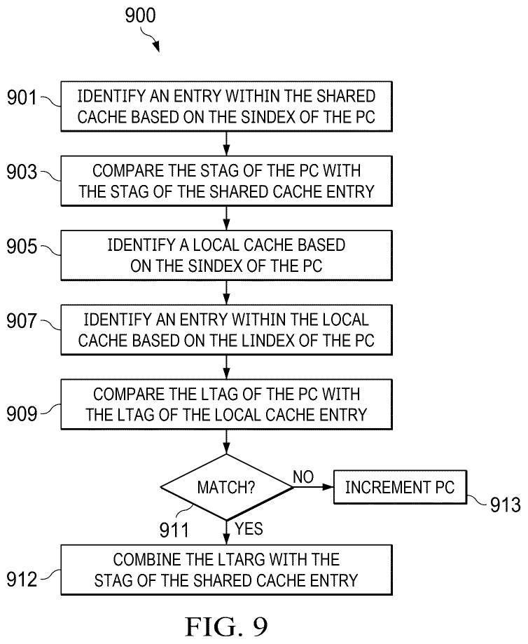

FIG. 9 illustrates branch prediction process 900 in an implementation. Branch prediction process 900 is representative of software for predicting branches within the program code of a computing system. For example, branch prediction process 900 may be representative of branch prediction method 200 of FIG. 2 or branch prediction process 600 of FIG. 6. Branch prediction process 900 may be implemented in the context of program instructions that, when executed by a suitable computing system, direct the processing circuitry of the computing system to operate as follows, referring parenthetically to the steps in FIG. 9. For the purposes of explanation, branch prediction process 900 will be explained with the elements of FIG. 8. This is not meant to limit the applications of branch prediction process 900, but rather to provide an example.

To begin, processing circuitry associated with operating environment 800 utilizes index 804 of PC register 801 to identify the entry of the first branch table within shared buffer 806 that stores the necessary data for performing a first comparison (step 901). For example, index 804 may be representative of a 2-bit binary value which corresponds to an entry of shared buffer 806. Thus, if index 804 is equal to 00, then the processing circuitry is configured to utilize data from the first entry (i.e., first row) of shared buffer 806 to determine if the PC value of PC register 801 represents the address of a previously executed branch instruction.

Next, the processing circuitry performs the first comparison between upper tag 802 and the upper tag of a previously executed branch instruction (step 903). For example, after indexing to the appropriate entry within shared buffer 806, the processing circuitry may perform a comparison between upper tag 802, and the upper instruction tag stored by the first entry of upper instruction tag column 807. Once compared, the processing circuitry is configured to identify the appropriate local buffer for performing a second comparison (step 905).

In an implementation, to identify the appropriate local buffer for performing the second comparison, the processing circuitry is configured to again utilize index 804 to determine which local buffer is storing the necessary data for performing the second comparison. For example, if index 804 is equal to 00, then the processing circuitry may be configured to utilize data from the respective second branch table of local buffer 808. Alternatively, if index 804 is equal to 01, then the processing circuitry may be configured to utilize data from the respective second branch table of local buffer 812.

Next, the processing circuitry determines the appropriate entry within the respective second branch table of the respective local buffer for performing the second comparison based on the value of index 805 (step 907). For example, if index 804 is equal to 00 and index 805 is equal to 011, then the processing circuitry is configured to utilize data from the fourth entry (i.e., fourth row) of local buffer 808 to perform the second comparison. In an implementation to perform the second comparison the processing circuitry is configured to compare lower tag 803 with the lower tag of a previously executed branch instruction (step 909).

For example, after indexing to the appropriate entry within local buffer 808, the processing circuitry may perform a comparison between lower tag 803, and the lower instruction tag stored by the first entry of lower instruction tag column 810. Once compared, the processing circuitry is configured to output a result of the first and second comparisons (step 911).

In an implementation, if the processing circuitry determines that either upper tag 802 or lower tag 803 do not respectively match the upper tag or lower tag of the previously executed branch instruction, then the processing circuitry may conclude that the PC value of PC register 801 is not representative of an address of a branch instruction, and in response, increment the PC value (step 913). For example, the processing circuitry may be configured to increment the PC value to be representative of the address of the next instruction stored in memory. Alternatively, if the processing circuitry determines that both upper tag 802 and lower tag 803 respectively match the upper and lower tags of the previously executed branch instruction, then the processing circuitry may conclude that the current PC value of PC register 801 is representative of a branch instruction address, and in response, determine to replace the current PC value with a target address (step 912).

In an implementation, to determine to replace the current PC value with the target address, the processing circuitry is configured to reference a table that stores the execution history of the previously executed branch instructions. For example, the processing circuitry may reference a pattern history table which is configured to store the likeliness of a branch instruction branching to the same location as it did on its most recent execution.

If the processing circuitry determines that it is not likely that the current PC value will again branch to the target address, then the processing circuitry is configured to increment the current PC value (step 913). Alternatively, if the processing circuitry determines that it is likely that the current PC value will again branch to the target address, then the processing circuitry is configured to replace the current PC value with the generated target address.

In an implementation, to generate the target address, the processing circuitry is configured to combine the upper tag of the previously executed branch instruction (identified during the first comparison) with the lower target tag stored by a lower target tag column of the appropriate local buffer. For example, the processing circuitry may combine the upper tag of the previously executed branch instruction with the lower target tag stored by the first entry of lower target tag column 811. It should be noted that branch prediction process 900 is a repetitive process. For example, branch prediction process 900 may be executed for each PC value that is stored by PC register 801.

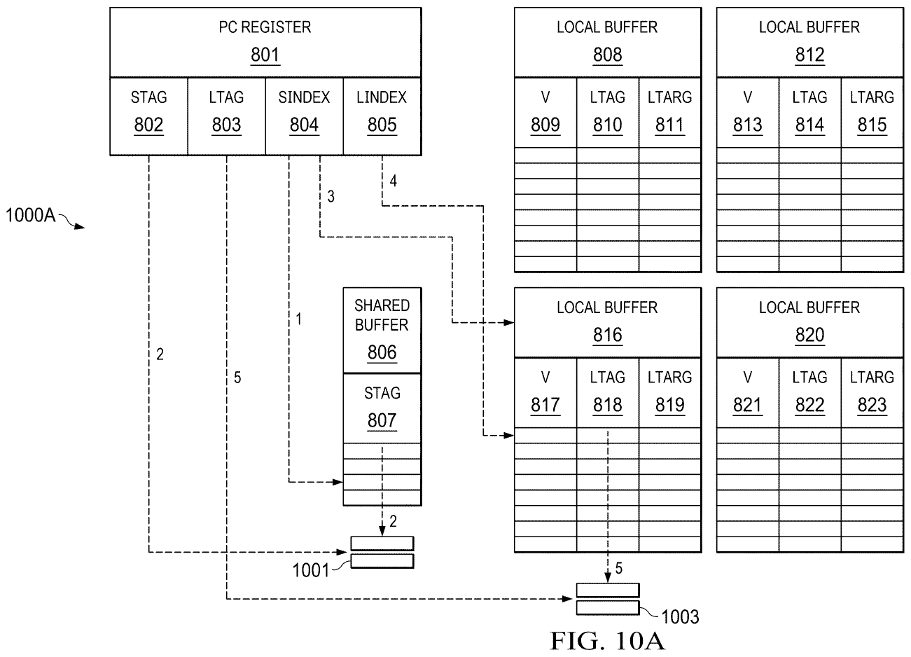

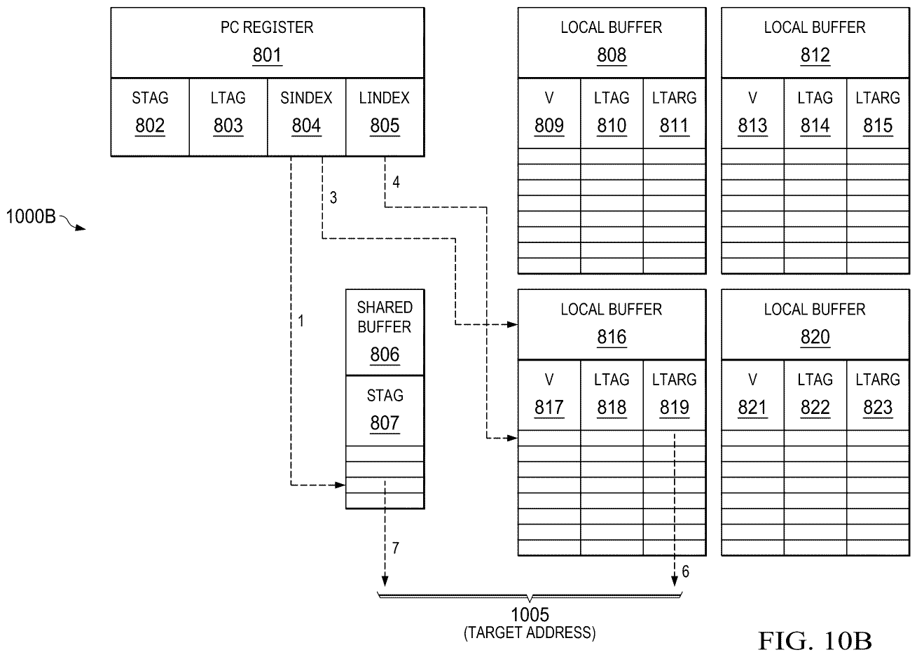

FIGS. 10A & 10B illustrate an operational scenario for performing branch prediction with respect to the elements of FIG. 8. More specifically, FIG. 10A illustrates a first stage of the operational scenario while FIG. 10B illustrates a second stage of the operational scenario. As such, FIGS. 10A and 10B include PC register 801, shared buffer 806, local buffer 808, local buffer 812, local buffer 816, and local buffer 820.

Turning to the first stage of the operational scenario, FIG. 10A depicts stage 1000A in an implementation. Stage 1000A is representative of a stage for determining if the PC value of PC register 801 represents the address of a previously executed branch instruction. To begin, the processing circuitry is configured determine the appropriate entry within the first branch table of shared buffer 806 based on index 804. For example, index 804 may cause the processing circuitry to index to the third entry of shared buffer 806.

Next, the processing circuitry is configured to execute operation 1001. Operation 1001 is representative of a comparison operation between upper tag 802 and the upper tag of the previously executed branch instruction. For example, the processing circuitry may be configured to determine if the bits of upper tag 802 match the bits stored by the third entry of upper instruction tag column 807.

Once compared, the processing circuitry is configured determine the appropriate local buffer also based on index 804. For example, index 804 may cause the processing circuitry to index to local buffer 816. Next, the processing circuitry is configured determine the appropriate entry within the corresponding second branch table of the identified local buffer based on index 805. For example, index 805 may cause the processing circuitry to index to the first entry of local buffer 816.

Next, the processing circuitry is configured to determine if the data of the first entry has been corrupted. For example, the processing circuitry may reference the valid bit of validity column 817 to confirm the data stored by the remaining columns of the first entry of local buffer 816 is uncorrupted. Once confirmed, the processing circuitry is configured to execute operation 1003.

Operation 1003 is representative of a comparison operation between lower tag 803 and the lower tag of the previously executed branch instruction. For example, the processing circuitry may be configured to determine if the bits of lower tag 803 match the bits stored by the first entry of lower instruction tag column 818. In an implementation, if the processing circuitry determines the results of operations 1001 and 1003 both comprise a match, then the processing circuitry may conclude that the current PC value of PC register 801 is representative of a branch instruction address.

Now turning to the next figure, FIG. 10B illustrates stage 1000B in an implementation. Stage 1000B is representative of a stage for generating target address 1005. Target address 1005 is representative of the next address to be stored by PC register 801. More specifically, target address 1005 represents the processing circuitry's prediction on the outcome from executing the current instruction represented by the PC value of PC register 801.

To begin, the processing circuitry is configured to combine the upper tag of the previously executed branch instruction with the lower tag of the target instruction which the previously executed branch instruction branched to. For example, the processing circuitry may combine the upper tag stored by the third entry of shared buffer 806 with the lower target tag stored by the first entry of lower target tag column 819 to generate target address 1005. Once combined, the processing circuitry may replace the current PC value with target address 1005.

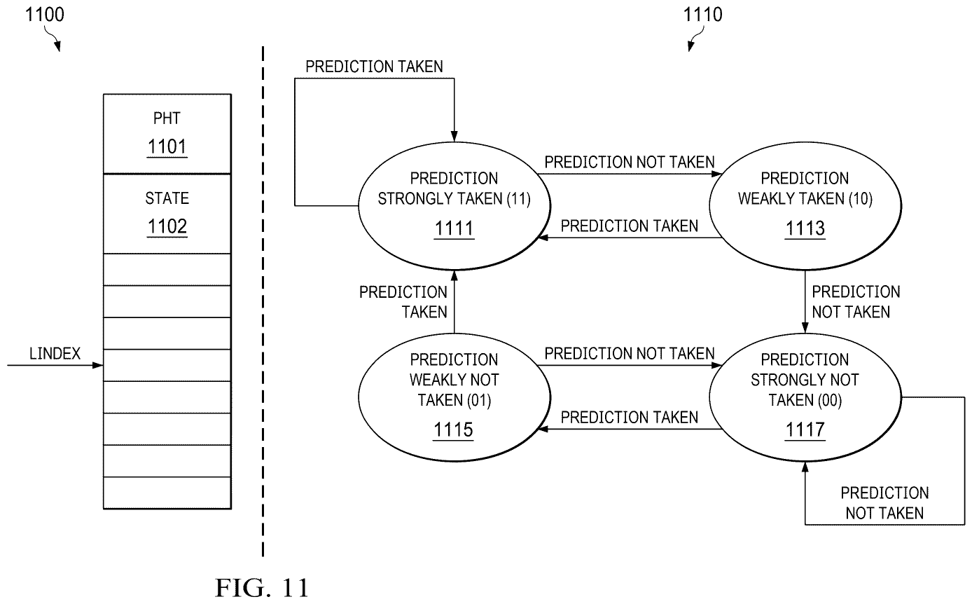

FIG. 11 illustrates operation 1100 of a state machine (e.g., within the branch prediction circuitry 117) in an implementation. State machine 1100 is representative of a computational model, employed by processing circuitry, to determine the likelihood of a previously executed branch instruction branching to a predicted target address. For example, in the context of FIG. 1, state machine 1100 may be employed by branch prediction circuitry 117 to determine the likelihood of a current PC value branching to a predicted target address. State machine 1100 includes pattern history table 1101 and model 1110.

Pattern history table 1101 is representative of a table which includes multiple entries, such that each entry is configured to store the execution history of a previously executed branch instruction. For example, pattern history table 1101 may store the execution history for the data stored by local buffer 505 and shared buffer 511. Alternatively, pattern history table 1101 may store the execution history for the data stored by shared buffer 806 and local buffers 808, 812, 816, and 820. Pattern history table includes state column 1102.

State column 1102 is representative of a column which stores the current state of previously executed branch instructions, such that the current state of a branch instruction describes the likelihood of the branch instruction branching to the same location as it did on a previous execution. For example, if a conditional branch instruction branched to a first location on a first execution, then the current state of the conditional branch instruction describes the likelihood of the instruction again branching to the first location on a next execution. In an implementation, the current state of a previously executed branch instruction is representative of a 2-bit value that corresponds to the states of model 1110.

Model 1110 is representative of a model configured to determine the current state of previously executed branch instructions. For example, model 1110 may be executed by processing circuitry configured to form predictions on the next instruction to be fetched from memory (e.g., branch prediction circuitry 117 or control circuitry 309). Model 1110 includes state 1111, state 1113, state 1115, and state 1117.

States 1111, 1113, 1115, and 1117 are representative of 2-bit states which describe the likelihood of a branch instruction branching to the same location as it did on a previous execution, such that state 1111 represents the most likely state (i.e., 11), state 1113 represents the second most likely state (i.e., 10), state 1115 represents the third most likely state (i.e., 01), and state 1117 represents the least likely state (i.e., 00). In an implementation, when employed by processing circuitry, state machine 1100 causes the processing circuitry to populate pattern history table 1101 with a state from model 1110.

For example, after a first execution of a branch instruction, the processing circuitry may designate an entry of pattern history table 1101 to the branch instruction and populate said entry with state 1111. Then, on a next execution of the instruction, the processing circuitry may index to the appropriate entry within pattern history table 1101 based on an index of the instruction (e.g., index 504 or index 805), determine the current state of the branch instruction is state 1111, and in response, predict the instruction to branch to the same instruction as it did on a last execution. If the prediction is correct, then the processing circuitry is configured to keep the current state of the branch instruction as state 1111. Alternatively, if the prediction was incorrect, then the processing circuitry is configured to update the current state of the branch instruction to state 1113.

In operation, the processing circuitry may continue to update pattern history table 1101 based on the outcome of executing the branch instructions. Meaning, if a prediction is correct, then the processing circuitry is configured to update the state of the instruction to more likely, but if the prediction is incorrect, then the processing circuitry is configured to update the state of the instruction to less likely. For example, if the current state of an instruction is state 1113, and the prediction is correct, then the state of the instruction is updated to state 1111. Alternatively, if the prediction is incorrect, then the state of the instruction is updated to state 1117.

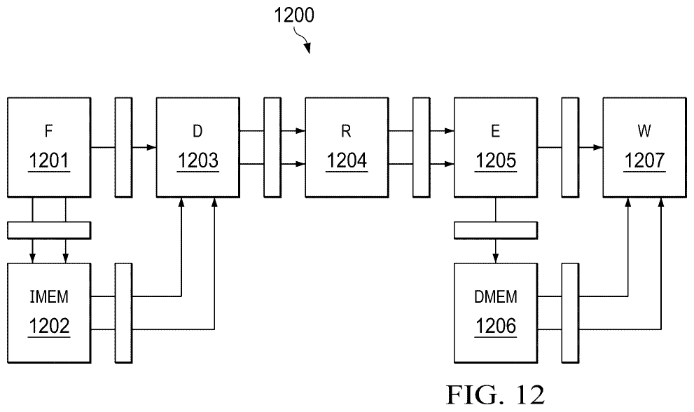

FIG. 12 illustrates system 1200 in an implementation. System 1200 is representative of an exemplary system configured to perform branch prediction during the course of normal system operations. For example, system 1200 may be representative of operating environment 100, system 300, operating environment 500, or operating environment 800. System 1200 includes, but is not limited to, fetch circuitry 1201, instruction memory 1202, decode circuitry 1203, register read circuitry 1204, execute circuitry 1205, data memory 1206 and register write circuitry 1207.

Fetch circuitry 1201 is representative of processing circuitry configured to fetch data from memory. For example, fetch circuitry 1201 may be representative of fetch circuitry 115 of FIG. 1. In an implementation, fetch circuitry 1201 is further representative of processing circuitry configured to form predictions on the next instructions to be fetched from memory. For example, fetch circuitry 1201 may further represent branch prediction circuitry 117 of FIG. 1.

In operation, fetch circuitry 1201 is configured to fetch program instructions from memory based on the address data stored by a register (e.g., PC register 116) of fetch circuitry 1201. Fetch circuitry 1201 is further configured to determine if the address data stored by the register represents the address of a previously executed branch instruction. For example, fetch circuitry 1201 may include multiple instruction buffers (e.g., shared buffer 303 and local buffer 305), and be configured to execute branch prediction method 200, branch prediction process 600, or branch prediction process 900 with respect to its instruction buffers.

If fetch circuitry 1201 determines that the address data of its register is representative of a previously executed branch instruction, then fetch circuitry 1201 is configured to determine to fetch a target instruction from memory based on the execution history of the previously executed branch instruction. Alternatively, if fetch circuitry 1201 determines that the address data of its register is not representative of a previously executed branch instruction, then fetch circuitry 1201 is configured to fetch the next instruction stored in memory. Output of fetch circuitry is stored by instruction memory 1202 and is provided to decode circuitry 1203.

Instruction memory 1202 is representative of an on-chip memory, configured to store the output of fetch circuitry 1201. For example, instruction memory 1202 may be representative of RAM, SRAM, cached memory, or another memory of the like configured to store instruction data. In an implementation, instruction memory 1202 is coupled to decode circuitry 1203.

Decode circuitry 1203 is representative of a processing circuitry which is configured to decode the data of an instruction into a readable format. For example, decode circuitry 1203 may be configured to read-out the instruction data stored by instruction memory 1202 into a format which may be understood by the remaining processing circuitries of system 1200. Output of decode circuitry 1203 is provided to register read circuitry 1204.

Register read circuitry 1204 is representative of a processing circuitry which is configured to read out data from a first location and write the data to a second location. For example, register read circuitry 1204 may be configured to read out the output data of decode circuitry 1203 and provide the output data to execute circuitry 1205.

Execute circuitry 1205 is representative of a processing circuitry configured to execute program instructions. For example, execute circuitry 1205 may be representative of execute circuitry 119 of FIG. 1. In an implementation, execute circuitry 1205 receives decoded instructions from register read circuitry 1204, and in response, executes the opcode of the decoded instructions. Output of execute circuitry 119 is stored by data memory 1206 and is provided to register write circuitry 1207.

Data memory 1206 is representative of another on-chip memory, configured to store the output of execute circuitry 1205. For example, data memory 1206 may be representative of RAM, SRAM, cached memory, or another memory of the like configured to store instruction data. In an implementation, instruction memory 1206 is coupled to register write circuitry 1207.

Register write circuitry 1207 is representative of a processing circuitry configured to form the output of an executed instruction. For example, register write circuitry 1207 may be configured to analyze the output of execute circuitry 120, and write the output to a register coupled to register write circuitry 1207.

Advantageously, the branch prediction capabilities of system 1200 allow the system to accurately fetch instructions from memory, thereby mitigating the number of times system 1200 must flush out a misprediction from the execution pipeline. For example, if fetch circuitry 1201 forms a misprediction, and the mispredicted instruction is later identified by execute circuitry 1205, then, system 1200 must waste execution cycles flushing out the instructions which were fetched based on the data of the mispredicted instruction from the subsequent stages of the execution pipeline (i.e., fetch circuitry 1201, decode circuitry 1203, and register read circuitry 1204).

As will be appreciated by one skilled in the art, aspects of the present invention may be embodied as a system, method, or computer program product. Accordingly, aspects of the present invention may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the disclosure. Those skilled in the art will also appreciate that the features described above may be combined in various ways to form multiple implementations. As a result, the invention is not limited to the specific implementations described above, but only by the claims and their equivalents.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A device comprising:
branch prediction circuitry comprising:
comparison circuitry configured to:
perform a first comparison between a first portion of a program counter value and a first portion of a cached address; and
perform a second comparison between a second portion of the program counter value and a second portion of the cached address; and
control circuitry configured to determine whether to replace the program counter value with a target address associated with the cached address based on the first comparison and the second comparison.

2. The device of claim 1, wherein the control circuitry is further configured to increment the program counter value based on the first comparison determining that the first portion of the program counter value does not match the first portion of the cached address or the second comparison determining that the second portion of the program counter value does not match the second portion of the cached address.

3. The device of claim 2, wherein the program counter value is stored in a register coupled to the branch prediction circuitry, wherein the program counter value includes an instruction address, wherein the first portion of the program counter value includes a first section of the instruction address, and wherein the second portion of the program counter value includes a second section of the instruction address.

4. The device of claim 3, wherein the branch prediction circuitry further includes a first memory and allocation circuitry, wherein the allocation circuitry is configured to cache addresses in the first memory and wherein, to cache the addresses in the first memory, the allocation circuitry is configured to:
identify one or more branch instruction addresses, and for each branch instruction address of the one or more branch instruction addresses:
identify a first section of the branch instruction address;
cache the first section of the branch instruction address within a first table of the first memory, wherein the first section of the branch instruction address includes the first portion of the cached address, and wherein the first table is stored by a first location of the first memory;
identify a second section of the branch instruction address; and
cache the second section of the branch instruction address within a second table of the first memory, wherein the second section of the branch instruction address includes the second portion of the cached address, and wherein the second table is stored by a second location of the first memory.

5. The device of claim 4, wherein the first location of the first memory includes a local buffer configured to store the first table, and wherein to perform the first comparison, the comparison circuitry is configured to:
identify a first entry of the first table based on a first index of the program counter value, wherein the first entry of the first table stores the first portion of the cached address; and
compare the first portion of the program counter value with the first portion of the cached address.

6. The device of claim 5, wherein the second location of the first memory includes a shared buffer configured to store the second table, wherein the comparison circuitry is configured to perform the second comparison when the first comparison determines that the first portion of the program counter value matches the first portion of the cached address, and wherein to perform the second comparison, the comparison circuitry is configured to:
identify a first entry of the second table based on an address pointer stored by the first entry of the first table, wherein the first entry of the second table stores the second portion of the cached address; and
compare the second portion of the program counter value with the second portion of the cached address.

7. The device of claim 6, wherein to cause the program counter value to be replaced with the target address, the control circuitry is configured to:
identify a first portion of the target address stored by the first entry of the first table;
identify a second entry of the second table based on a target address pointer stored by the first entry of the first table, wherein the second entry of the second table stores a second portion of the target address; and
combine the first portion of the target address with the second portion of the target address.

8. The device of claim 4, wherein the first location of the first memory includes a shared buffer configured to store the first table, and wherein to perform the first comparison, the comparison circuitry is configured to:
identify a first entry of the first table based on a first index of the program counter value, wherein the first entry of the first table stores the first portion of the cached address; and
compare the first portion of the program counter value with the first portion of the cached address.

9. The device of claim 8, wherein the second location of the first memory includes one or more local buffers, wherein the one or more local buffers are each configured to store a corresponding second table, and wherein to perform the second comparison, the comparison circuitry is configured to:
identify a designated corresponding second table from the one or more local buffers based on the first index of the program counter value;
identify a first entry of the designated corresponding second table based on a second index of the program counter value, wherein the first entry of the corresponding second table stores the second portion of the cached address; and
compare the second portion of the program counter value with the second portion of the cached address.

10. The device of claim 9, wherein to cause the program counter value to be replaced with the target address, the control circuitry is configured to:
identify a first portion of the target address stored by the first entry of the first table;
identify a second portion of the target address stored by the first entry of the designated corresponding second table; and
combine the first portion of the target address with the second portion of the target address.

11. A processing device comprising:
execution circuitry configured to execute code fetched from a memory;
fetch circuitry configured to fetch the code from the memory based at least on a program counter value; and
branch prediction circuitry configured to:
perform a first comparison between a first portion of a program counter value and a first portion of a cached address;
perform a second comparison between a second portion of the program counter value and a second portion of the cached address; and
determine whether to replace the program counter value with a target address associated with the cached address based on whether the first comparison determines that the first portion of the program counter value matches the first portion of the cached address and whether the second comparison determines that the second portion of the program counter value matches the second portion of the cached address.

12. The processing device of claim 11, wherein the branch prediction circuitry is further configured to increment the program counter value based on the first comparison determining that the first portion of the program counter value does not match the first portion of the cached address or the second comparison determining that the second portion of the program counter value does not match the second portion of the cached address.

13. The processing device of claim 12, wherein the program counter value is stored in a register coupled to the branch prediction circuitry, wherein the program counter value includes an instruction address, wherein the first portion of the program counter value includes a first section of the instruction address, and wherein the second portion of the program counter value includes a second section of the instruction address.

14. The processing device of claim 13, wherein the branch prediction circuitry further includes a first memory, wherein the branch prediction circuitry is configured to cache addresses in the first memory and wherein, to cache the addresses in the first memory, the branch prediction circuitry is configured to:
identify one or more branch instruction addresses from the code, and for each branch instruction address of the one or more branch instruction addresses:
identify a first section of the branch instruction address;
cache the first section of the branch instruction address within a first table of the first memory, wherein the first section of the branch instruction address includes the first portion of the cached address, and wherein the first table is stored by a first location of the first memory;
identify a second section of the branch instruction address; and
cache the second section of the branch instruction address within a second table of the first memory, wherein the second section of the branch instruction address includes the second portion of the cached address, and wherein the second table is stored by a second location of the first memory.

15. The processing device of claim 14, wherein the first location of the first memory includes a local buffer configured to store the first table, wherein the second location of the first memory includes a shared buffer configured to store the second table, wherein the branch prediction circuitry is configured to perform the second comparison when the first comparison determines that the first portion of the program counter value matches the first portion of the cached address, and wherein to perform the first and second comparisons, the branch prediction circuitry is configured to:
identify a first entry of the first table based on a first index of the program counter value, wherein the first entry of the first table stores the first portion of the cached address;
compare the first portion of the program counter value with the first portion of the cached address;
identify a first entry of the second table based on an address pointer stored by the first entry of the first table, wherein the first entry of the second table stores the second portion of the cached address; and
compare the second portion of the program counter value with the second portion of the cached address.

16. The processing device of claim 15, wherein to cause the program counter value to be replaced with the target address, the branch prediction circuitry is configured to:
identify a first portion of the target address stored by the first entry of the first table;
identify a second entry of the second table based on a target address pointer stored by the first entry of the first table, wherein the second entry of the second table stores a second portion of the target address; and
combine the first portion of the target address with the second portion of the target address.

17. The processing device of claim 14, wherein the first location of the first memory includes a shared buffer configured to store the first table, wherein the second location of the first memory includes one or more local buffers each configured to store a corresponding second table, and wherein to perform the first and second comparisons, the branch prediction circuitry is configured to:
identify a first entry of the first table based on a first index of the program counter value, wherein the first entry of the first table stores the first portion of the cached address;
compare the first portion of the program counter value with the first portion of the cached address;
identify a designated corresponding second table from the one or more local buffers based on the first index of the program counter value;
identify a first entry of the designated corresponding second table based on a second index of the program counter value, wherein the first entry of the designated corresponding second table stores the second portion of the cached address; and
compare the second portion of the program counter value with the second portion of the cached address.

18. The processing device of claim 17, wherein to cause the program counter value to be replaced with the target address, the branch prediction circuitry is configured to:
identify a first portion of the target address stored by the first entry of the first table;
identify a second portion of the target address stored by the first entry of the designated corresponding second table; and
combine the first portion of the target address with the second portion of the target address.

19. A method comprising:
performing a first comparison between a first portion of a program counter value and a first portion of a cached address;
performing a second comparison between a second portion of the program counter value and a second portion of the cached address; and
determining whether to replace the program counter value with a target address associated with the cached address based on the first comparison determining that the first portion of the program counter value matches the first portion of the cached address and the second comparison determining that the second portion of the program counter value matches the second portion of the cached address.

20. The method of claim 19, further comprising, incrementing the program counter value based on the first comparison determining that the first portion of the program counter value does not match the first portion of the cached address or the second comparison determining that the second portion of the program counter value does not match the second portion of the cached address.
